(19) United States
(12) Patent Application Publication
(10) Pub. No.: US 2023/0322508 A1
(43) Pub. Date: Oct. 12, 2023

(54) TRAY OPENING/CLOSING DEVICE, INCLUDING RAIL HAVING PLURALITY OF RECESSES ON UPPER FACE AND SLIDER HAVING PROTRUSION ON LOWER END PORTION TO BE FITTED IN ONE OF RECESSES, AND IMAGE FORMING APPARATUS

(71) Applicant: KYOCERA Document Solutions Inc., Osaka (JP)

(72) Inventor: Doan Huu PHAN, Osaka (JP)

(73) Assignee: KYOCERA Document Solutions Inc., Osaka (JP)

(21) Appl. No.: 18/122,735

(22) Filed: Mar. 17, 2023

(30) Foreign Application Priority Data
Mar. 22, 2022 (JP) 2022-045762

(51) Int. Cl. B65H 1/04

(52) U.S. Cl. CPC B65H 1/04; B65H 2405/324; B65H 2801/06

(57) ABSTRACT

A tray opening/closing device includes a tray, a rail, and a slider. The rail includes a plurality of recesses, formed on an upper face, and aligned in a longitudinal direction of the rail. The slider includes a stopper and a cap portion. The stopper includes a protrusion provided on a lower end portion, to be fitted with one of the recesses on the upper face of the rail, when the cap portion assumes a state of being disengaged. The stopper includes a contact portion provided on an upper end portion, and configured to be pushed back by an inner wall of the cap portion, upon contacting the inner wall, when the cap portion assumes a state of covering. When the contact portion is pushed back upon contacting the inner wall of the cap portion, the protrusion is disengaged from the recess, owing to elastic deformation of the stopper.

### INCORPORATION BY REFERENCE

This application claims priority to Japanese Patent Application No.2022-045762 filed on Mar. 22, 2022, the entire contents of which are incorporated by reference herein.

### BACKGROUND

The present disclosure relates to a tray opening/closing device for openably supporting a tray that opens or closes an opening in a sidewall of an apparatus main body, and to an image forming apparatus including the tray opening/closing device. In particular, the disclosure relates to a technique to simplify the opening and closing operation of the tray.

The image forming apparatus is for forming an image on a recording sheet. The image forming apparatus includes a paper feeding device that supplies the recording sheet. Examples of the paper feeding device include a paper cassette for storing a plurality of recording sheets, and a manual bypass tray. The manual bypass tray is provided in an opening in the sidewall of the apparatus main body, so as to open or close the opening, by being opened or closed.

A first image forming apparatus, configured to openably support a manual feeding tray in a storage compartment of the apparatus main body, is generally known. In the first image forming apparatus, when the user opens the manual feeding tray and sets a plurality of recording sheets thereon, a recording sheet lifting plate lifts up the leading edge of the recording sheets, and applies the leading edge of the uppermost one of the recording sheets to a feed roller, so that the feed roller draws out and delivers the recording sheet. In the first image forming apparatus, in addition, when the user closes the manual feeding tray and stores the manual feeding tray in the storage compartment of the apparatus main body, the recording sheet lifting plate rotates together with the manual feeding tray, to be accommodated inside the storage compartment, and a stopper restricts the recording sheet lifting plate from sticking out from the storage compartment.

In addition, a second image forming apparatus that includes a manual bypass tray, openably supported by the wall of the apparatus main body, is generally known. In the case of the second image forming apparatus, the user opens the manual bypass tray, and sets a plurality of recording sheets thereon. The manual bypass tray includes a tray main body on which the plurality of recording sheets are to be placed, and a lift unit. The lift unit includes a lifting plate that lifts up the portion of the recording sheet on the side of the leading edge, a lifting spring that pushes up the lifting plate, and a pair of cursors for aligning the respective side edges of the recording sheets. When the manual bypass tray is closed, a guide portion of each cursor is abutted against an opposing wall, and a portion of the lifting plate on the downstream side in the transport direction is shifted downward. Accordingly, the lifting plate smoothly moves downward, despite the manual bypass tray being closed, when the lifting plate is pushed up thus being located on the upper side. Therefore, the lifting plate is kept from interfering with a part of the apparatus main body, and the apparatus main body can be exempted from being damaged.

### SUMMARY

The disclosure proposes further improvement of the foregoing techniques.

In an aspect, the disclosure provides a tray opening/closing device including a tray, a rail, and a slider. The tray is supported by a sidewall of an apparatus main body, so as to pivot about a first shaft provided along a lower end of an opening of the sidewall, and configured to open or close the opening, by being opened or closed. The rail is provided on the tray, and extends in a direction intersecting the first shaft. The slider is supported by the rail, so as to move in a longitudinal direction of the rail. The rail includes a plurality of recesses, formed on an upper face of the rail and aligned in the longitudinal direction of the rail. The slider includes a stopper and a cap portion. The stopper is formed so as to protrude from the upper face of the rail. The cap portion is configured to reciprocate along a protruding direction, and selectively assume one of a state of covering the stopper and a state of being disengaged from the stopper, by a reciprocating motion. The stopper includes a protrusion provided on a lower end portion thereof, to be fitted with one of the plurality of recesses on the upper face of the rail, when the cap portion assumes the state of being disengaged. The stopper includes a contact portion provided on an upper end portion thereof, and configured to be pushed back by an inner wall of the cap portion upon contacting the inner wall, when the cap portion assumes the state of covering. When the contact portion is pushed back upon contacting the inner wall of the cap portion, the protrusion is disengaged from one of the plurality of recesses, owing to elastic deformation of the stopper.

In another aspect, the disclosure provides an image forming apparatus including the foregoing tray opening/closing device, a sheet transport device, and an image forming device. The sheet transport device transports a recording sheet placed on the tray of the tray opening/closing device. The image forming device forms an image on the recording sheet transported by the sheet transport device.

### BRIEF DESCRIPTION OF THE DRAWINGS

FIG. 1 is a perspective view showing the appearance of an image forming apparatus including a tray opening/closing device according to an embodiment of the disclosure;

FIG. 2 is a perspective view showing the tray opening/closing device;

FIG. 3A is a perspective view showing a rail and a slider, in a state where a cap portion of the slider is erected upright;

FIG. 3B is a vertical cross-sectional view showing the rail and the slider, in the state where the cap portion of the slider is erected upright;

FIG. 4A is a perspective view showing the rail and the slider, in the state where the cap portion of the slider is laid down;

FIG. 4B is a vertical cross-sectional view showing the rail and the slider, in the state where the cap portion of the slider is laid down;

FIG. 5A is an enlarged view of the stopper of the slider and the rail;

FIG. 5B is an enlarged view of a protrusion of the stopper and a recess of the rail;

FIG. 6A is a perspective view showing the rail and the slider, in the state where a frame and the stopper are accommodated inside a frame portion of the cap portion of the slider;

FIG. 6B is a vertical cross-sectional view showing the rail and the slider, in the state where the frame and the stopper are accommodated inside the frame portion of the cap portion of the slider;

FIG. 7 is an enlarged view of the stopper of the slider and the rail, in the state where the protrusion of the stopper is disengaged from the recess of the rail;

FIG. 8 is a cross-sectional view showing a manual bypass tray in an opened state;

FIG. 9 is a cross-sectional view showing the cap portion of the slider in the laid-down position;

FIG. 10 is a cross-sectional view showing the manual bypass tray in a half-closed state; and

FIG. 11 is a cross-sectional view showing the manual bypass tray completely closed.

### DETAILED DESCRIPTION

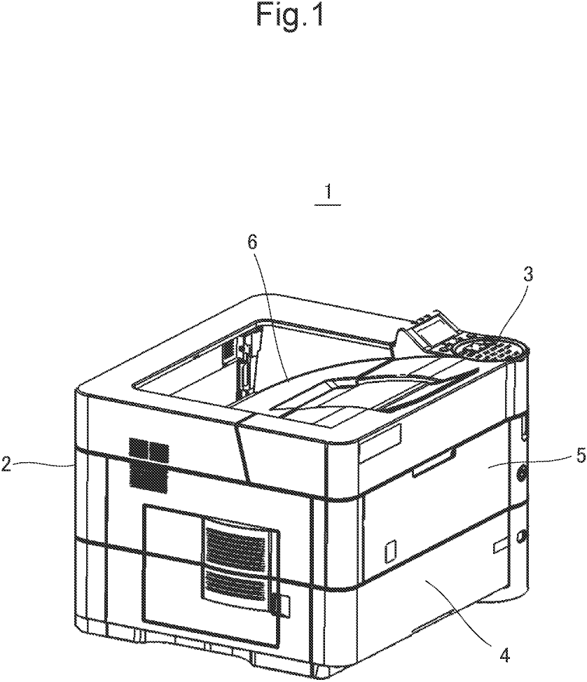

Hereafter, an embodiment of the disclosure will be described, with reference to the drawings. FIG. 1 is a perspective view showing the appearance of an image forming apparatus 1 including a tray opening/closing device 10 according to the embodiment of the disclosure. As shown in FIG. 1, the image forming apparatus 1 is a printer. An apparatus main body 2 includes a plurality of components for realizing various functions of the image forming apparatus 1. For example, the apparatus main body 2 includes an operation device 3, a paper cassette 4, a manual bypass tray 5, and an output tray 6. Inside the apparatus main body 2, an image forming device and a fixing device are provided.

The image forming device forms an image represented by image data, on a recording sheet supplied from the paper cassette 4 or the manual bypass tray 5, by electrophotography using toner. The recording sheet having the image formed thereon undergoes a fixing process by the fixing device, and then delivered to the output tray 6.

The operation device 3 includes, for example, a start key, an enter key for confirming an inputting operation, and numeric keys for inputting numerals. Through the operation device 3, the user’s instructions to execute various operations and processings are inputted. The operation device 3 also includes a display device for displaying, for example, operation guides for the user.

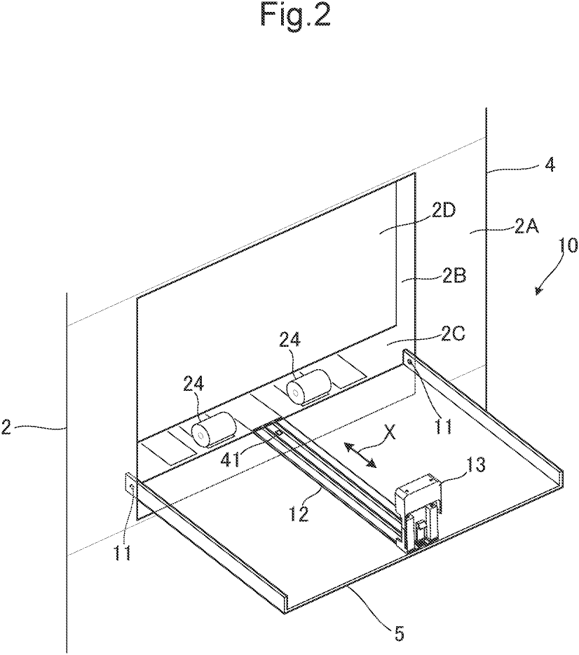

FIG. 2 is a perspective view showing the tray opening/closing device 10. On the tray opening/closing device 10, the manual bypass tray 5 is openably provided in a cavity 2B in a sidewall 2A of the apparatus main body 2. In the upper region of the cavity 2B of the sidewall 2A, a wall portion 2D is provided. In the lower region of the cavity 2B of the sidewall 2A, an opening 2C communicating with the inside of the apparatus main body 2 is provided. The manual bypass tray 5 is pivotably supported by a pair of shafts 11, located along the lower end of the opening 2C. The manual bypass tray 5 can be made to protrude from the cavity 2B, or accommodated in the cavity 2B, by being opened or closed. In other words, the manual bypass tray 5 opens up or closes the opening 2C, by being opened or closed.

On the manual bypass tray 5, a rail 12 and a slider 13 are provided. The rail 12 extends in a direction X intersecting the opening 2C. The slider 13 supported by the rail 12, so as to move in the longitudinal direction of the rail 12 (same as direction X).

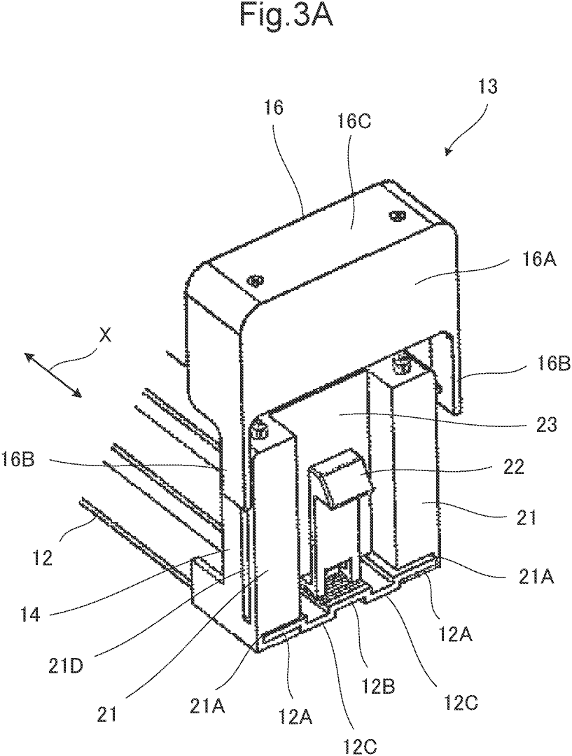

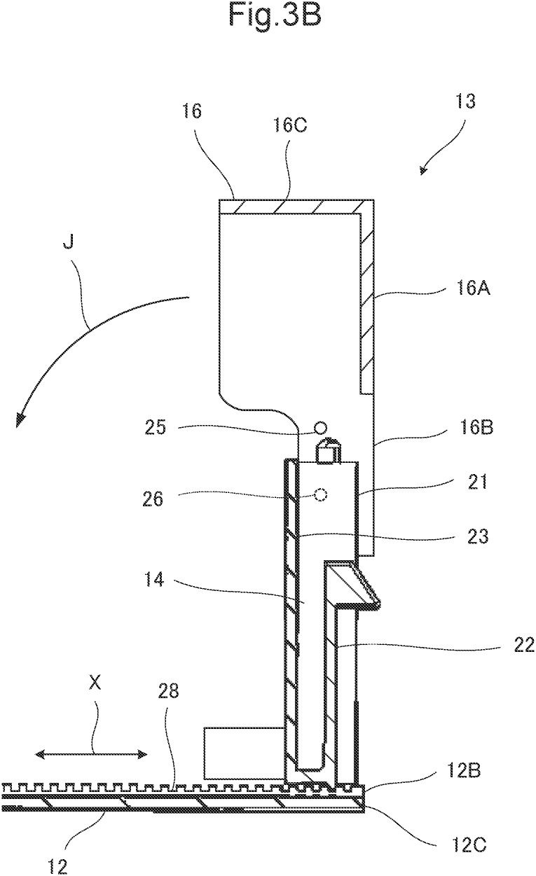

FIG. 3A is a perspective view showing the rail 12 and the slider 13. FIG. 3B is a vertical cross-sectional view showing the rail 12 and the slider 13. As shown in FIG. 3A and FIG. 3B, the rail 12 includes a pair of guide plates 12A, a positioning plate 12B, and two bottom plates 12C. The pair of guide plates 12A each extend in the direction X. The positioning plate 12B is located between the pair of guide plates 12A. The two bottom plates 12C each serve to connect one of the guide plates 12A and the positioning plate 12B. The guide plates 12A, the positioning plate 12B, and the bottom plates 12C each have a corrugated cross-sectional shape.

The slider 13 includes a frame 14 and a cap portion 16. The frame 14 is supported by the rail 12, so as to move in the direction X. The cap portion 16 is supported by the frame 14. The frame 14 includes a pair of columnar portions 21, a stopper 22, and a main plate 23. The pair of columnar portions 21 are located on the respective end portions of the frame 14. The stopper 22 is formed so as to protrude upward, between the pair of columnar portions 21. The main plate 23 supports the pair of columnar portions 21 and the stopper 22, as a unified structure. The columnar portions 21 of the frame 14 each include a slit 21A, formed at the lower end portion of the columnar portion 21. In each of the slits 21A, one of the guide plates 12A on the end portion of the rail 12 is slidably inserted. Accordingly, the frame 14 (i.e., slider 13) is supported by the rail 12, so as to move in the direction X.

The cap portion 16 includes a frame portion 16A, and a pair of arm portions 16B. The arm portions 16B are formed so as to extend from the respective end portions of the frame portion 16A. On the inner wall of each of the arm portions 16B, a pair of protrusions 25 and 26, aligned in the longitudinal direction of the arm portion 16B, are provided.

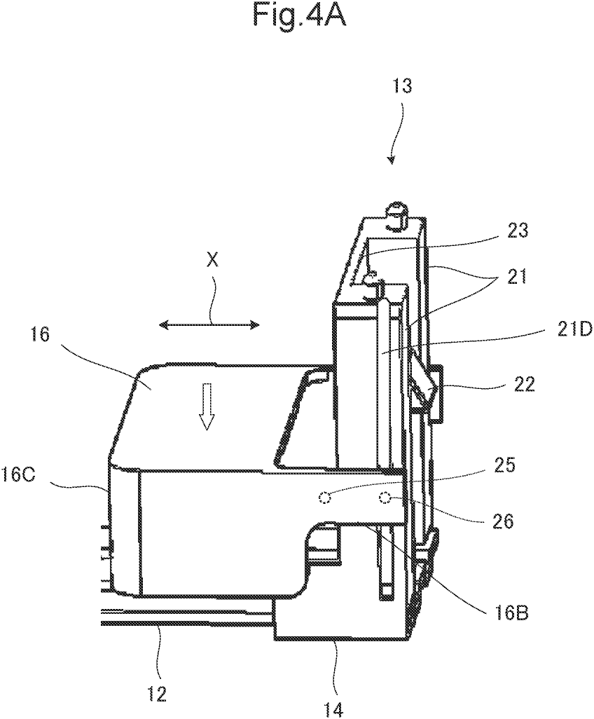

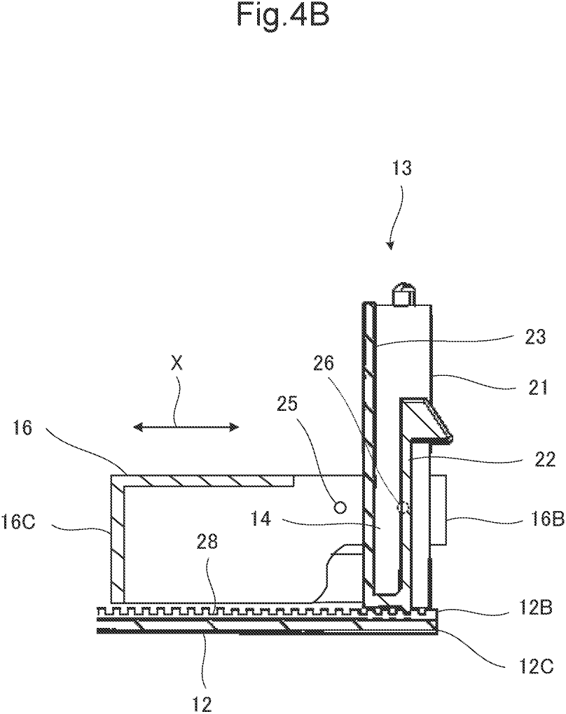

The columnar portions 21 of the frame 14 each include a guide groove 21D, formed in the sidewall so as to extend in the height direction of the columnar portion 21. The guide grooves 21D are each formed so as to reach the upper end of the corresponding columnar portion 21 (see FIG. 4A). The cap portion 16 can be mounted on the frame 14, by locating the columnar portions 21 of the frame 14 between the arm portions 16B of the cap portion 16, and fitting the pair of protrusions 25 and 26 on the arm portion 16B in the guide groove 21D of the corresponding columnar portion 21. Because of the pair of protrusions 25 and 26 on the arm portion 16B being guided by the guide groove 21D of the columnar portion 21, the cap portion 16 is supported by the frame 14, so as to reciprocate along the direction projecting from the upper face of the rail 12. With such reciprocating motion, the cap portion 16 can selectively assume one of a state of covering the stopper, and a state of being disengaged from the stopper.

In FIG. 3A and FIG. 3B, only the lower protrusion 26 on the arm portion 16B of the cap portion 16 is fitted in the guide groove 21D of the columnar portion 21 of the frame 14. In this state, the cap portion 16 can be made to pivot about the lower protrusion 26 on the arm portion 16B (about an axis orthogonal to direction X) in the direction of arrow J, to a horizontal posture, and then moved downward as shown in FIG. 4A. As result, as shown in FIG. 4A and FIG. 4B, a wall portion 16C of the frame portion 16A of the cap portion 16 is oriented so as to oppose the opening 2C of the apparatus main body 2. At the same time, the stopper 22 of the frame 14 assumes an upright posture on the rail 12.

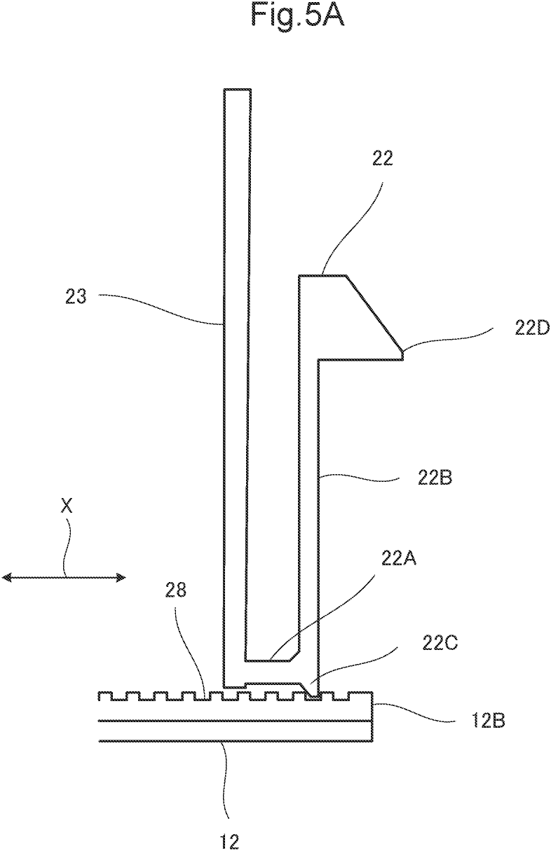

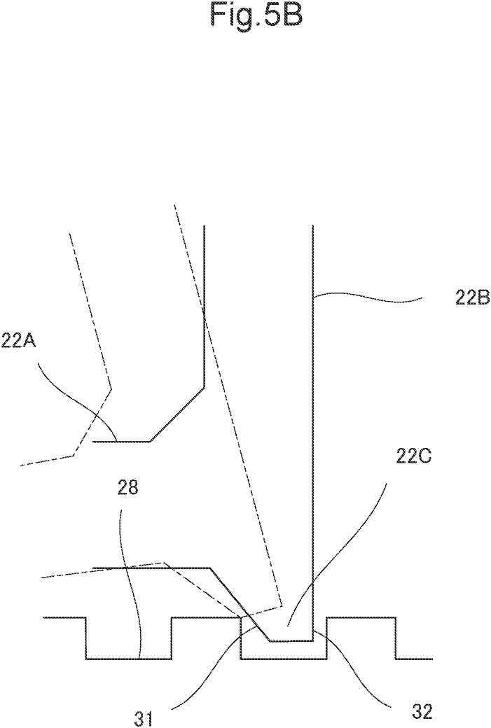

Referring to FIG. 5A, the stopper 22 includes a joint portion 22A, an arm portion 22B, a protrusion 22C, and a contact portion 22D. The joint portion 22A serves to connect between the lower end of the arm portion 22B and the main plate 23. The arm portion 22B extends straightly upward from the end of the joint portion 22A, on the opposite side of the main plate 23. The protrusion 22C is formed on the lower end of the arm portion 22B. The contact portion 22D is formed on the upper end of the arm portion 22B, so as to protrude in the direction opposite to the main plate 23.

In addition, a plurality of recesses 28 are formed on the upper face of the positioning plate 12B of the rail 12, in alignment along the direction X.

When the cap portion 16 is disengaged from the stopper 22 of the frame 14, and the stopper 22 is erected upright with respect to the rail 12, as shown in FIG. 4A and FIG. 4B, the protrusion 22C of the stopper 22 is engaged with one of the plurality of recesses 28 on the positioning plate 12B of the rail 12, as shown in FIG. 5A. Thus, the slider 13 can be positioned at a desired position on the rail 12 in the direction X.

Further, as shown in FIG. 5B, the protrusion 22C of the stopper 22 includes a sloped surface 31 and an orthogonal surface 32. The protrusion 22C is formed in such a shape that the sloped surface 31 and the orthogonal surface 32 come closer to each other, toward the tip portion of the protrusion 22C. When the manual bypass tray 5 is assuming the posture shown in FIG. 2, by being made to stop pivoting upon opening the apparatus main body 2, the sloped surface 31 is oriented to the opening 2C of the apparatus main body 2, and inclined with respect to the upper face of the rail 12. When the manual bypass tray 5 is assuming the posture shown in FIG. 2, the orthogonal surface 32 is oriented in the direction opposite to the opening 2C, and orthogonal to the upper face of the rail 12.

Since the orthogonal surface 32 of the protrusion 22C is thus opposed to the inner wall of the recess 28 on the positioning plate 12B, upon being fitted therein, the slider 13 is restricted from moving in the direction opposite to the opening 2C, along the rail 12.

In contrast, when an attempt is made to move the slider 13 toward the opening 2C along the rail 12, when the sloped surface 31 of the protrusion 22C is engaged with the recess 28 on the positioning plate 12B, the stopper 22 is deformed to the shape indicated by dash-dot lines in FIG. 5B, and the sloped surface 31 escapes from the recess 28. Therefore, the slider 13 can be made to move toward the opening 2C, by pushing the slider 13 toward the opening 2C.

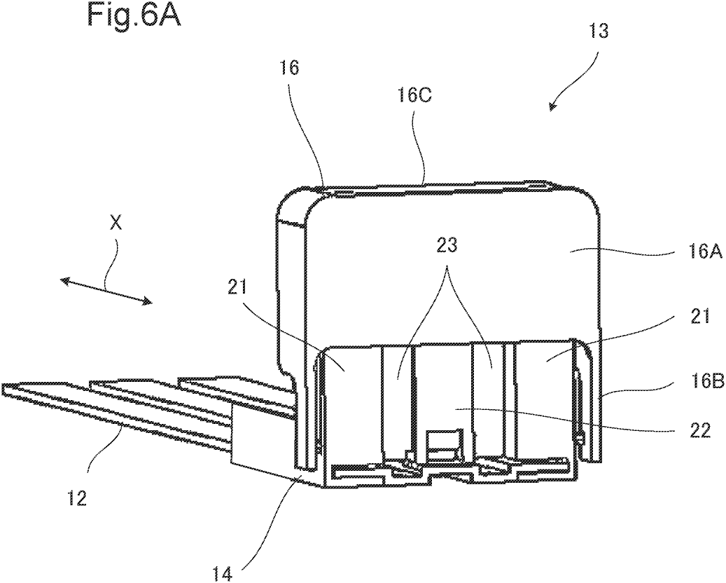

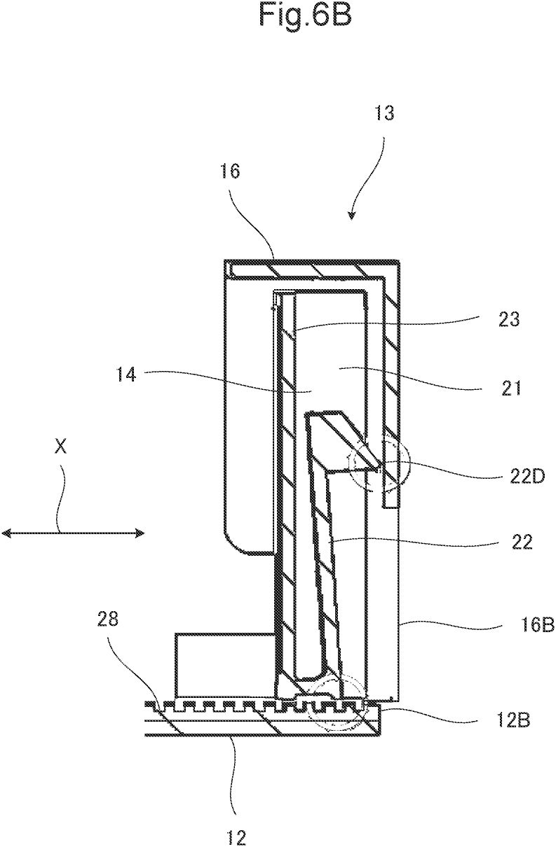

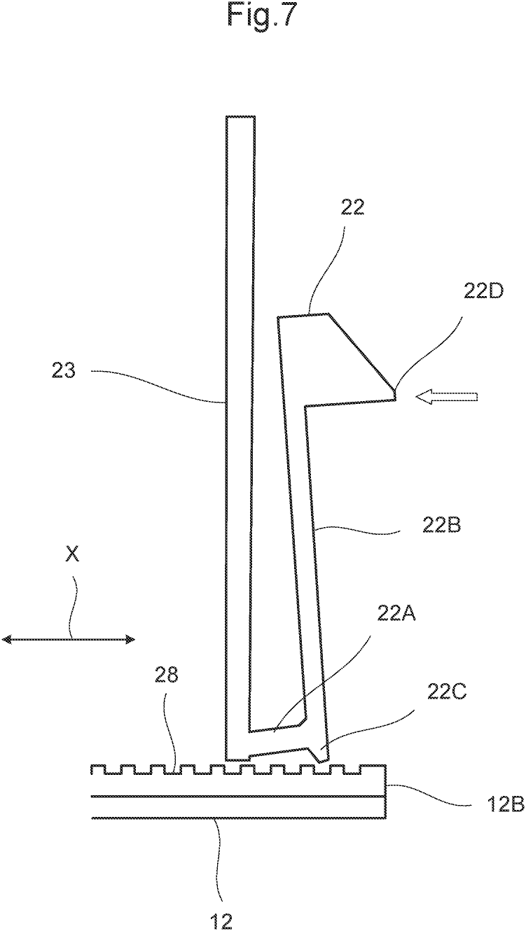

When the pair of protrusions 25 and 26 on the arm portion 16B of the cap portion 16 are both fitted in the guide groove 21D of the columnar portion 21 of the frame 14, and the cap portion 16 is pushed downward so as to cover the stopper 22, as shown in FIG. 6A and FIG. 6B, the frame 14 and the stopper 22 are accommodated inside the frame portion 16A of the cap portion 16. In this case, because of the engagement between the pair of protrusions 25 and 26 and the guide groove 21D, the cap portion 16 is restricted from pivoting, and therefore the posture of the cap portion 16 is maintained. As result, the contact portion 22D of the stopper 22 is displaced backward, by being abutted against the inner wall of the frame portion 16A of the cap portion 16, as shown in FIG. 6B. Consequently, as shown in FIG. 7, the stopper 22 is elastically deformed, so that the protrusion 22C of the stopper 22 is lifted up, to the position where the protrusion 22C is disengaged from one of the plurality of recesses 28 on the positioning plate 12B.

In this state, the slider 13 can be made to move along the rail 12, both in the direction toward the opening 2C, and in the direction away from the opening 2C.

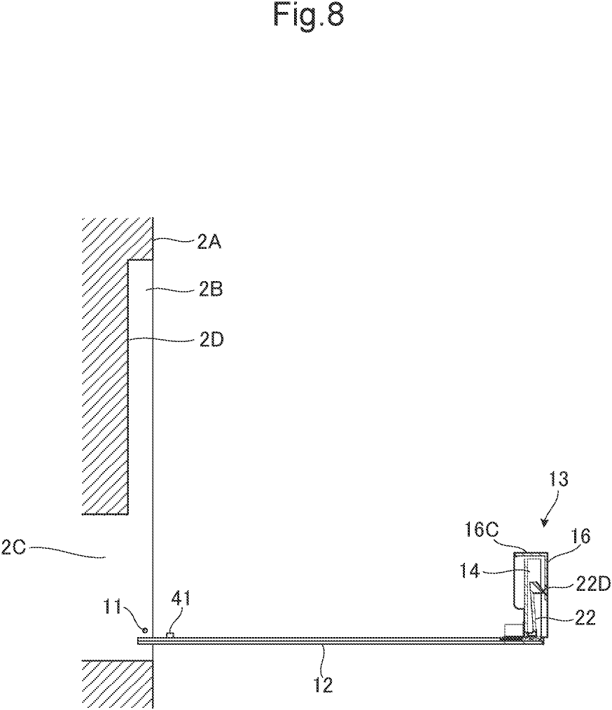

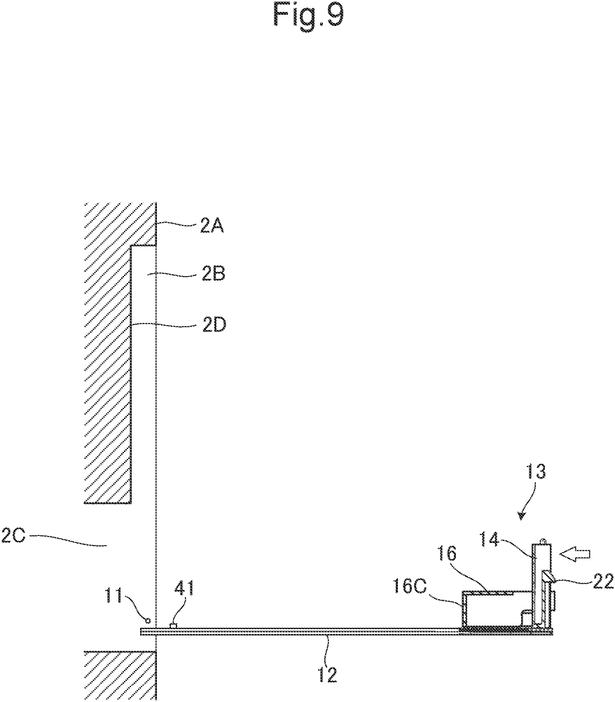

With the tray opening/closing device 10 configured as above, when the user opens the manual bypass tray 5 to thereby open up the opening 2C of the apparatus main body 2, as shown in FIG. 8, the frame 14 is accommodated inside the frame portion 16A of the cap portion 16, and the protrusion 22C of the stopper 22 is disengaged from the recess 28 of the positioning plate 12B. The user moves the slider 13 along the rail 12 in the direction opposite to the opening 2C, and places a plurality of recording sheets on the manual bypass tray 5. Then the user pulls up the frame portion 16A of the cap portion 16 as shown in FIG. 3A and FIG. 3B, and sets the wall portion 16C of the cap portion 16 to the posture opposing the opening 2C of the apparatus main body 2, thereby setting the stopper 22 of the frame 14 to the posture upright with respect to the rail 12, as shown in FIG. 4A and FIG. 4B. At this point, the protrusion 22C of the stopper 22 is engaged with the recess 28 on the positioning plate 12B of the rail 12. Further, the user moves the slider 13 along the rail 12 toward the opening 2C, and sets the slider 13 at the position where the wall portion 16C of the cap portion 16 contacts the trailing edge of the recording sheets, as shown in FIG. 9, thereby aligning the trailing edge of the recording sheets. The user also inserts the leading edge of the recording sheet into the position under the pair of feed roller 24 (see FIG. 2) located inside the opening 2C. When the feed rollers 24 rotate in this state, the recording sheets are sequentially transported by the feed rollers 24 toward the image forming device located inside the apparatus main body 2, so that images are sequentially formed by the image forming device, on the respective recording sheets.

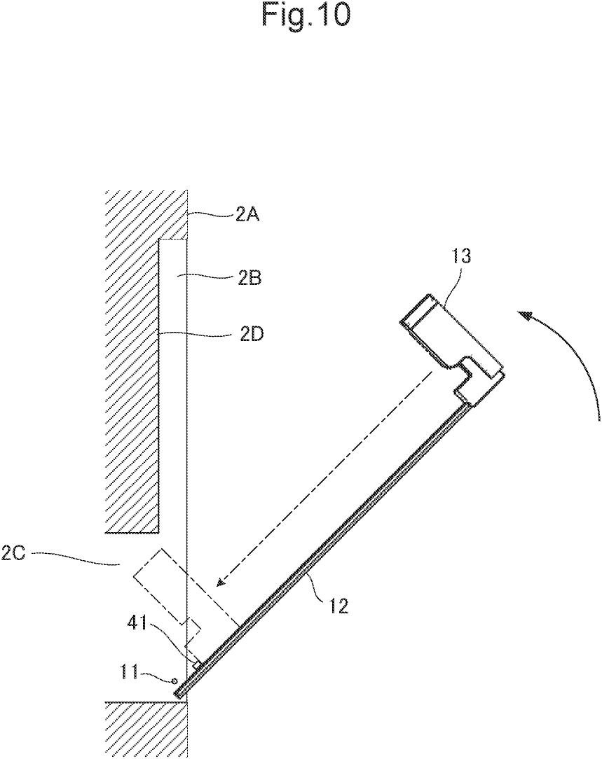

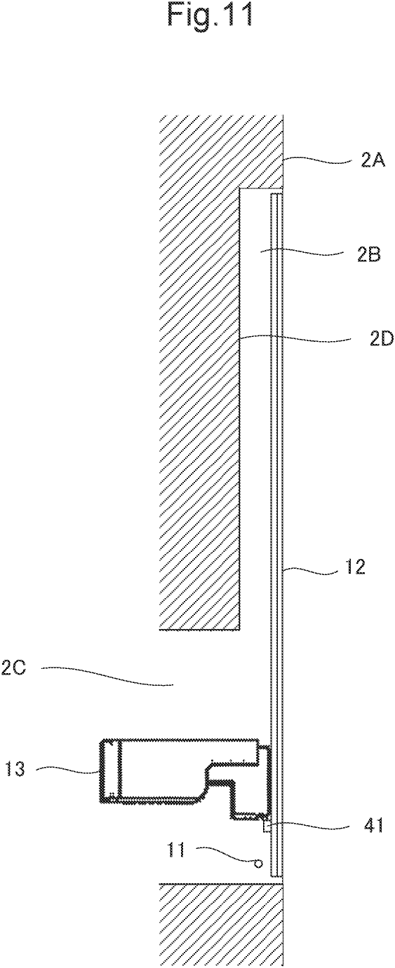

When the manual bypass tray 5 is to be closed thereafter, so that the opening 2C of the apparatus main body 2 is closed, the user fits the protrusion 25 on the arm portion 16B of the cap portion 16, in the guide groove 21D of the columnar portion 21 of the frame 14, as shown in 6A and FIG. 6B, before closing the manual bypass tray 5. Accordingly, the frame 14 is accommodated inside the frame portion 16A of the cap portion 16, and the protrusion 22C of the stopper 22 is disengaged from the recess 28 of the positioning plate 12B. Such an action enables the slider 13 to move along the rail 12, both in the direction toward the opening 2C, and in the direction away from the opening 2C. While the user is closing the manual bypass tray 5 as indicated by an arrow in FIG. 10, the slider 13 moves down, because of the self-weight, along the rail 12 toward the opening 2C. The slider 13 abuts against an elastic member 41 located at an end portion of the rail 12 on the side of the opening 2C in the longitudinal direction, and stops at a predetermined position. When the user completely closes the manual bypass tray 5 as shown in FIG. 11, the slider 13 is accommodated in the opening 2C. Accordingly, the slider 13 can be prevented from colliding with the wall portion 2D in the cavity 2B, and therefore the slider 13 and the wall portion 2D can be exempted from being damaged.

Now, there are cases where a slider for aligning the trailing edges of the respective recording sheets placed on the manual bypass tray is provided on the manual bypass tray. Such a slider is movable in the transport direction of the recording sheets on the manual bypass tray. The slider is made to abut against the trailing edge of the recording sheet, and stops at that position.

The slider has to be moved to the predetermined position, before the manual bypass tray is closed. When the manual bypass tray is closed, without the slider having been moved to the predetermined position, the slider interferes with the apparatus main body.

In the case of the aforementioned first image forming apparatus, the recording sheet lifting plate rotates together with the manual feeding tray, at the same time that the manual feeding tray is closed, and is accommodated in the storage compartment. In the case of the second image forming apparatus, the portion of the lifting plate on the downstream side in the transport direction moves downward, at the same time that the manual bypass tray is closed, so that the interference between the lifting plate and a part of the apparatus main body can be avoided.

However, neither the first image forming apparatus nor the second image forming apparatus includes the slider configured as above. Therefore, those image forming apparatuses do not provide the technique to restrict the slider from interfering with the apparatus main body, when the manual bypass tray is closed.

With the tray opening/closing device 10 according to the foregoing embodiment, in contrast, the slider 13 provided on the manual bypass tray 5 moves into the opening 2C of the apparatus main body 2, while the manual bypass tray 5 is being closed. As result, the interference between the slider 13 and the wall portion 2D of the apparatus main body 2 can be avoided, without the need to take the trouble to move the slider 13.

Although the image forming apparatus according to the disclosure is exemplified by the printer in the foregoing embodiment, the image forming apparatus may be a multifunction peripheral, a copier, or a facsimile machine.

The configurations of the foregoing embodiment, described with reference to FIG. 1 to FIG. 11, are merely exemplary, and in no way intended to limit the disclosure to those configurations.

While the present disclosure has been described in detail with reference to the embodiments thereof, it would be apparent to those skilled in the art the various changes and modifications may be made therein within the scope defined by the appended claims.

What is claimed is:

1. A tray opening/closing device comprising:
a tray supported by a sidewall of an apparatus main body, so as to pivot about a first shaft provided along a lower end of an opening of the sidewall, and configured to open or close the opening, by being opened or closed;
a rail provided on the tray, and extending in a direction intersecting the first shaft; and
a slider supported by the rail, so as to move in a longitudinal direction of the rail,
wherein the rail includes a plurality of recesses, formed on an upper face of the rail and aligned in the longitudinal direction of the rail,
the slider includes a stopper formed so as to protrude from the upper face of the rail, and a cap portion configured to reciprocate along a protruding direction, and selectively assume one of a state of covering the stopper and a state of being disengaged from the stopper, by a reciprocating motion,
the stopper includes a protrusion provided on a lower end portion thereof, to be fitted with one of the plurality of recesses on the upper face of the rail, when the cap portion assumes the state of being disengaged,
the stopper includes a contact portion provided on an upper end portion thereof, and configured to be pushed back by an inner wall of the cap portion, upon contacting the inner wall, when the cap portion assumes the state of covering, and
when the contact portion is pushed back upon contacting the inner wall of the cap portion, the protrusion is disengaged from one of the plurality of recesses, owing to elastic deformation of the stopper.

2. The tray opening/closing device according to claim 1,
wherein the protrusion includes:
a sloped surface oriented toward the opening, and inclined with respect to the upper face of the rail, when the tray is opened from the apparatus main body; and
an orthogonal surface oriented in a direction opposite to the opening, and orthogonal to the upper face of the rail, when the tray is opened from the apparatus main body, and
the protrusion is formed such that the sloped surface and the orthogonal surface come closer to each other, toward a tip portion of the protrusion.

3. The tray opening/closing device according to claim 1,
wherein the cap portion includes a wall portion configured to pivot about a second axis orthogonal to the rail, when the cap portion assumes the state of being disengaged because of the reciprocating motion, and be oriented so as to oppose the opening, by being made to pivot.

4. The tray opening/closing device according to claim 1,
wherein an elastic member is provided at an end portion of the rail in the longitudinal direction, on a side of the opening.

5. An image forming apparatus comprising:
the tray opening/closing device according to claim 1;
a sheet transport device that transports a recording sheet placed on the tray of the tray opening/closing device; and
an image forming device that forms an image on the recording sheet transported by the sheet transport device.
